(19) United States
(12) Patent Application Publication
(10) Pub. No.: US 2013/0315514 A1
(43) Pub. Date: Nov. 28, 2013

(54) TWO-AXIS RECIRCULATING BEARING

(71) Applicants: Darin S. Williams, Tucson, AZ (US); Brian S. Scott, Vail, AZ (US)

(72) Inventors: Darin S. Williams, Tucson, AZ (US); Brian S. Scott, Vail, AZ (US)

(73) Assignee: Raytheon Company

(21) Appl. No.: 13/481,280

(22) Filed: May 25, 2012

(51) Int. Cl. F16C 29/06

(52) U.S. Cl. 384/43

(57) ABSTRACT

A recirculating bearing allows two-axis translational motion of a supported member along a bearing surface. The recirculating bearing combines a bearing surface upon which a plurality of ball bearings are free to roll in any direction along the bearing surface with a recirculating volume that recirculates ball bearings to and from the bearing surface. Unless limited by the application, the recirculating bearing provides for unlimited range of motion of the supported member in both axes.

### BACKGROUND OF THE INVENTION

1. Field of the Invention

This invention relates to recirculating bearings, and more particularly to a recirculating bearing that allows two-axis translational motion of a supported member along a bearing surface.

2. Description of the Related Art

Recirculating bearings are used to provide linear motion, and reversible linear motion, in applications that require a large range of motion, much greater than the extent of the bearing itself. For example, recirculating bearings are commonly used to support linear motion of machine parts and tables for heavy duty machine tools.

A typical recirculating bearing has a straight track section under load, a parallel straight return track section and two semi-cylindrical end sections that connect the track sections to form a closed track. Cylindrical rollers or spherical ball bearings recirculate around the closed track in response to linear motion of a supported member such as a machine part or table. Unless restricted by the application, the recirculating bearing has a unlimited range of motion in the linear direction parallel to the track.

### SUMMARY OF THE INVENTION

The following is a summary of the invention in order to provide a basic understanding of some aspects of the invention. This summary is not intended to identify key or critical elements of the invention or to delineate the scope of the invention. Its sole purpose is to present some concepts of the invention in a simplified form as a prelude to the more detailed description and the defining claims that are presented later.

The present invention provides a recirculating bearing that allows two-axis translational motion of a supported member along a bearing surface.

In an embodiment, a recirculating bearing that allows two-axis translational motion of a supported member comprises a surface member having a bearing surface upon which a plurality of ball bearings are free to roll in any direction along the bearing surface. The supported member is supported on one or more of the ball bearings allowing two-axis translational motion of the member along the bearing surface. A bearing housing having a recirculating volume connects opposing ends of the bearing surface to form a closed track for recirculating the ball bearings in response to translational motion of the supported member. Unless limited by the application, the recirculating bearing provides for unlimited range of motion of the supported member in both axes.

In an embodiment of a pedestal two-axis recirculating bearing, a disk is supported on a pedestal within the recirculating volume. The disk's top surface provides the bearing surface that allows the ball bearings to roll in any direction. The recirculating volume encompasses the perimeter of the disk such that motion of the supported member in any direction causes ball bearings to roll off the top of the disk into the recirculating volume and to recirculate in a nominal direction to follow the direction of motion of the supported member. Retaining elements may be used to retain three ball bearings in a triad configuration that rolls freely in any direction to reduce friction between the ball bearings.

In an embodiment of a dual-roller two-axis recirculating bearing, the surface member comprises first and second parallel rollers that form a channel along one axis to provide the bearing surface. The recirculating volume connects opposing ends of the channel to form the closed track. The ball bearings roll freely along the channel and recirculate around the closed track in response to translational motion of the supported member along the channel. The ball bearings roll in place causing counter rotation of the rollers in response to translational motion of the supported member along the other axis across the rollers. The freedom of the ball bearings to roll in any direction along the bearing surface is preserved by decomposing arbitrary motion into motion along both axes. The rollers may comprise a single unitary roller or a plurality of independently rolling segments.

In an embodiment of a cylindrical two-axis recirculating bearing, the supported member is a supported cylinder of diameter D1. The surface member and bearing housing comprise an inner cylinder in which the supported cylinder is placed, an outer cylinder and a pair of annular end caps. The inner cylinder's interior cylindrical surface provides the bearing surface. Ball bearings are free to roll axially along the bearing surface in response to translational motion of the supported cylinder axially along the bearing surface and to roll around the bearing surface in response to translational motion of the supported cylinder radially along the bearing surface. The inner cylinder is mounted axially within the outer cylinder to define the recirculating volume as an annular volume around the bearing surface. The annular end caps connect the bearing surface to the annular recirculating volume to form the closed track so that ball bearings rolling axially in response to axial translational motion of the supported cylinder recirculate in the closed track.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a diagram of a two-axis recirculating bearing;

FIGS. 2a and 2b are perspective views of an embodiment of a pedestal two-axis recirculating bearing with and without the ball bearings;

FIGS. 3a-3c are side and top views of a retaining element for retaining a triad of ball bearings to reduce friction;

FIGS. 4a and 4b are perspective and sectional views of an embodiment of a dual-roller two-axis recirculating bearing;

FIG. 5 is a side view of an embodiment of a dual-roller two-axis recirculating bearing having segmented rollers; and

FIGS. 6a through 6c are perspective, end and section views of an embodiment of a cylindrical two-axis recirculating bearing.

### DETAILED DESCRIPTION OF THE INVENTION

The present invention describes a recirculating bearing that allows two-axis translational motion of a supported member along a bearing surface. The recirculating bearing combines a bearing surface upon which a plurality of ball bearings are free to roll in any direction along the bearing surface with a recirculating volume that recirculates ball bearings to and from the bearing surface.

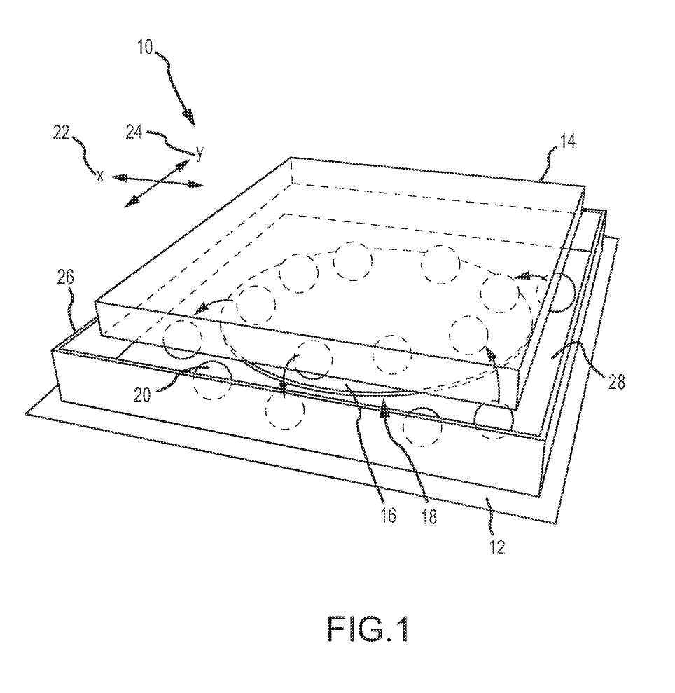

Referring now to FIG. 1, a two-axis recirculating bearing 10 attached to a mount 12 allows two-axis translational motion of a supported member 14 along a bearing surface 16. Recirculating bearing 10 includes a surface member 18 that supports bearing 16 surface upon which a plurality of spherical ball bearings 20 are free to roll in any direction along the bearing surface. The bearings 20 may roll along either axis e.g. x-axis 22 or y-axis 24, or at an angle to the axes. Supported member 18 is supported on one or more of the ball bearings 20 allowing two-axis translational motion of the member 18 along the bearing surface 16. In different embodiments, bearing surface 16 may be planar, spherical or cylindrical in which case the two-axis motion is translational along the planar, spherical or cylindrical surfaces, respectively. Unless limited by the application, the recirculating bearing provides for unlimited range of motion of the supported member in both axes. In certain embodiments, the recirculating bearing provides a range of motion that exceeds the extent of the bearing surface itself but is not unlimited. In other embodiments, the range of motion may be less than the width of the bearing surface.

A bearing housing 26 has a recirculating volume 28 that connects opposing ends of the bearing surface 16 to form a closed track for recirculating the ball bearings 20 in response to translational motion of the supported member 18. Unlike the bearing surface that is loaded by the supported member resting on the ball bearings, the recirculating volume provides unloaded surfaces that facilitate recirculation of the ball bearings. The volume extends away from the supported member at edges of the bearing surface, through which ball bearings rolling off one edge of the bearing surface move out of contact with the supported members, through which ball bearings on the nominally opposite side move onto the bearing surface and into contact with the supported member, and through which ball bearings are free to move between these two edges. The unloaded ball bearings will tend to move nominally in the direction of translational motion in order to recirculate, and are packed densely enough that bearings leaving the bearing surface will push other bearings through the recirculating volume onto the opposite side of the surface so that there are always bearings on the bearing surface. However, the bearings are free to move around and will do so. In “dual-roller” or “cylindrical” recirculating bearings, the ball bearings are only recirculating through the volume in response to translational motion in one axis. Motion in the other axis either causes the ball bearings to roll in place (dual-roller) or to roll around the inside of cylinder (cylindrical). In a “pedestal” embodiment, the ball bearings recirculating through volume in response to translation motion in either or both axes.

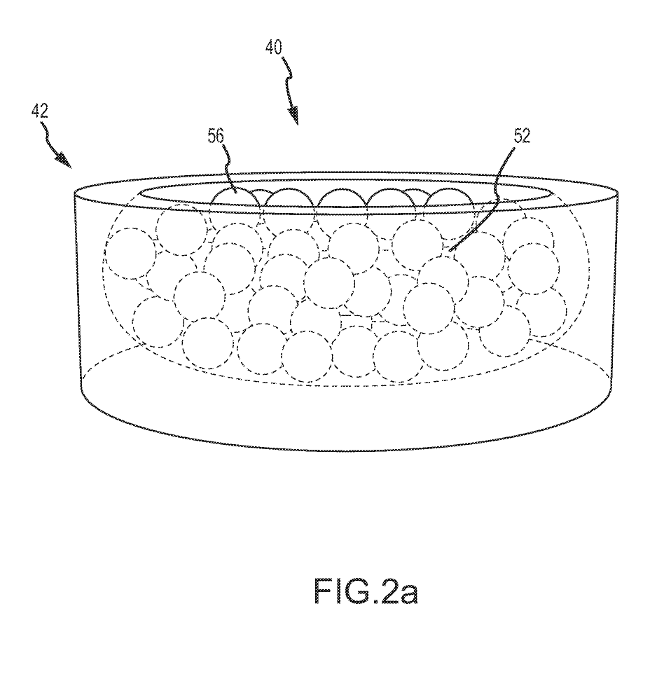

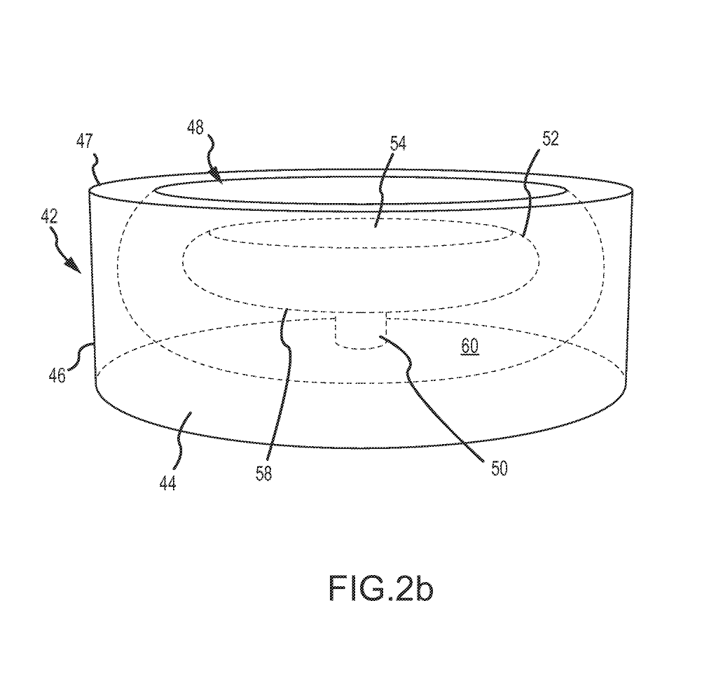

Referring now to FIGS. 2a-2b, an embodiment of a pedestal two-axis recirculating bearing 40 includes a cup 42 having a base 44, a wall 46 around the periphery of the base and a lip 47 that defines an opening 48. A pedestal 50 is supported on the base within the walls of the cup and supports a disk 52 in the opening of the cup. The diameter of disk 52 is greater than the diameter of pedestal 50. The disk's top surface 54 provides the bearing surface that allows ball bearings 56 to support the supported member (not shown) and roll in any direction. The disk's top surface 54 may be planar or have a spherical curvature to support two-axis translational motion of planar and spherical supported members, respectively, along the bearing surface.

The disk's lower surface 58, pedestal 50, base 44 and walls 46 of the cup form a recirculating volume 60. The recirculating volume encompasses the perimeter of the disk 52 such that motion of the supported member in any direction causes ball bearings 56 to roll off the top of the disk (i.e. the bearing surface) into the recirculating volume 60 and to recirculate in a nominal direction to follow the direction of motion of the supported member. The diameter of pedestal 50 is sufficiently narrow relative to the disk diameter so that the recirculating volume allows at least two ball bearings to move side-by-side in nominally the same direction for any direction of translational motion.

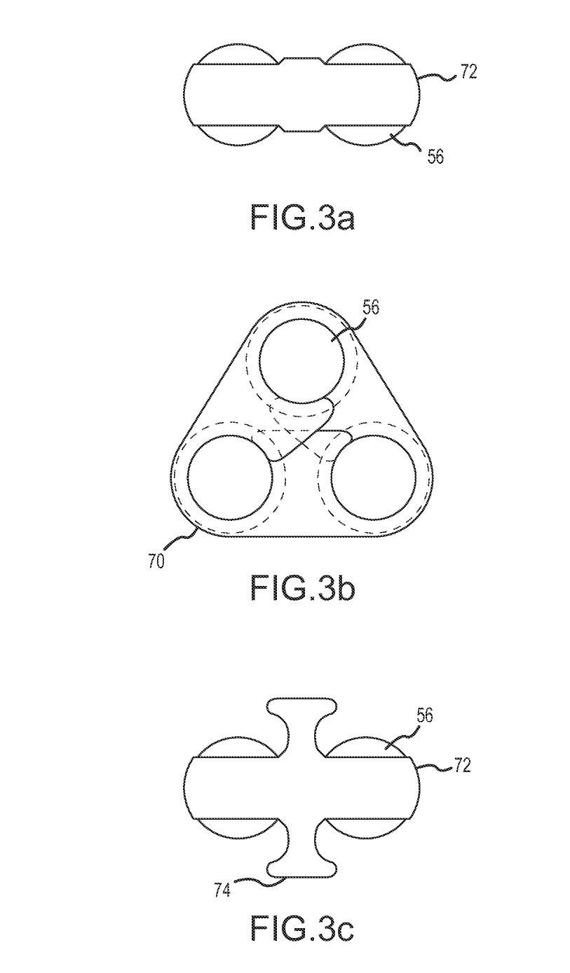

Referring now to FIGS. 3a-3c, for the pedestal bearing retaining elements 70 may be used to retain groups of three ball bearings 56 in a triad configuration that rolls freely in any direction. This is done to reduce friction between the ball bearings by avoiding direct contact between adjacent ball bearings whose surfaces would otherwise be rotating against each other at the contact point. The retaining element 70 is designed so that it is suspended parallel to the plane upon which the ball bearings are sitting by contact with the ball surfaces, but does not impede contact of the ball bearings with the surfaces above or below. Unlike a two-ball configuration, a three-ball configuration is sufficient to suspend the retainer 70 out of contact with the bearing and supported surfaces thereby reducing friction. In the embodiment shown, the retainer consists of a clip 72 with wings 74 which are crimped together to form the cavities retaining the individual ball bearings.

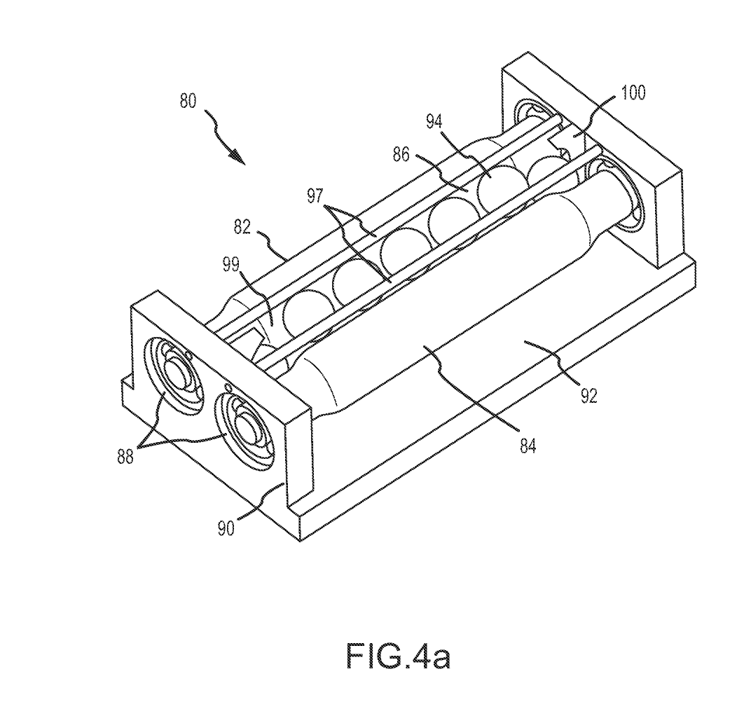

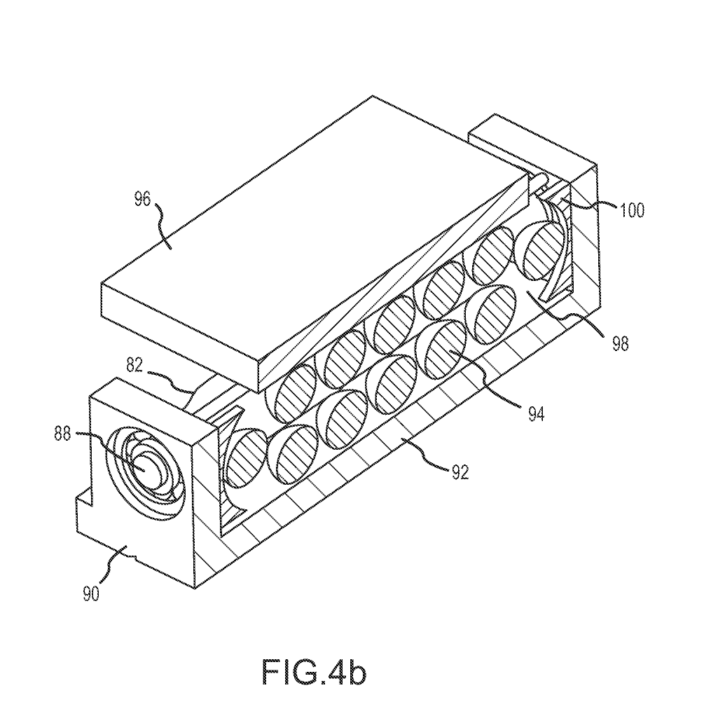

Referring now to FIGS. 4a-4b, an embodiment of a pedestal two-axis recirculating bearing 80 includes first and second parallel rollers 82, 84 that form a channel 86 along the x-axis to provide the bearing surface. Each roller is suitably held between a pair of rotational bearings 88 in end plates 90 above a base 92. The rollers are therefore free to rotate about an axis parallel to the x-axis. In this embodiment, each roller is a single generally cylindrically shaped element.

Ball bearings 94 roll freely along the channel 86 in response to translational motion of a supported member 96 along the channel (e.g. along the x-axis). The ball bearings 94 roll in place causing counter rotation of the rollers 82, 84 in response to translational motion of the supported member along the y-axis across the rollers. The freedom of the ball bearings 94 to roll in any direction along the bearing surface is preserved by decomposing arbitrary motion into motion along both the x and y-axes. Pins 97 may be placed between end plates 90 (below the level of the highest point of the ball bearings) to hold the bearings in place when the bearing is not in contact with the supported member.

A recirculating volume 98 connects opposing ends of the channel 86 to form the closed track. The ball bearings 94 roll freely along the channel and recirculate around the closed track in response to translational motion of the supported member along the channel. Recirculating volume 98 includes a lower track section that is defined between parallel rollers 82, 84 and base 92. The ball bearings are confined below by the base 92 and above and to both sides by rollers 82, 84 while given room roll parallel to the channel. The rollers may be tapered at both ends to create openings 99 at both ends of the channel that allow ball bearings 94 to pass back-and-forth. Two semi-cylindrical end sections 100 connect the openings at both ends of the channel 86 to the lower track section to form the closed track.

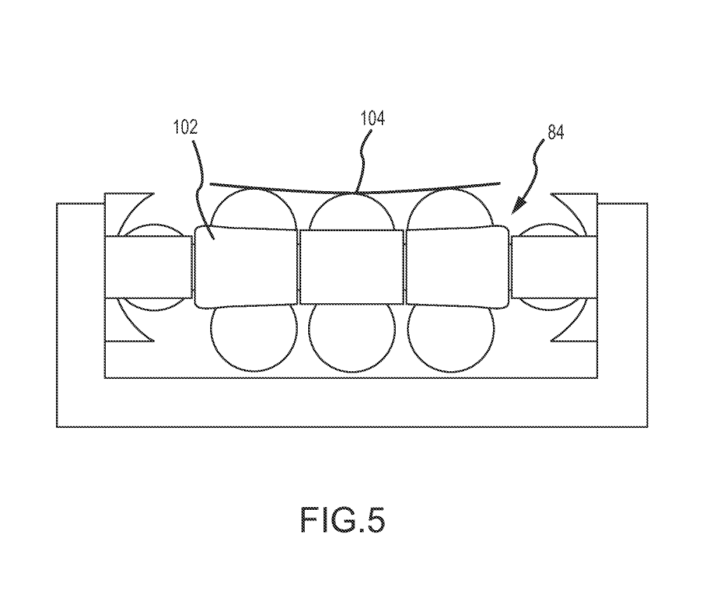

Referring now to FIG. 5, in an embodiment the rollers 82, 84 comprise a plurality of independently rolling segments 102. The spacing between adjacent rolling segments 102 is suitably less than the spacing between adjacent ball bearings 94 rolling along the channel so that only one ball bearing rides on a single segment at a time. This reduces slippage when the direction of translation motion of the supported member, hence of the ball bearings on the bearing surface is a compound motion along the channel and in place across the channel. The use of independently rolling segments also allows for the bearing surface to have a spherical curvature to accommodate a spherically curved supported member. As shown in FIG. 5, rolling segments 102 may have different diameters that are graded to form a piecewise approximation to a curved bearing surface 104.

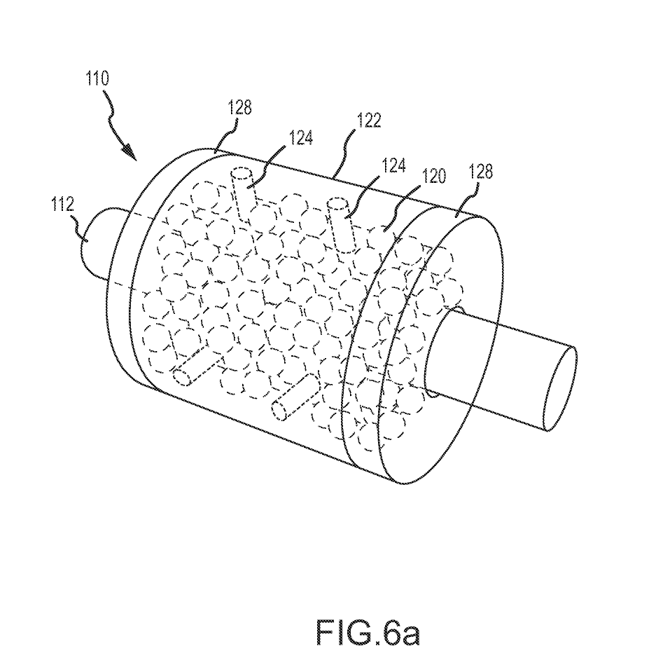

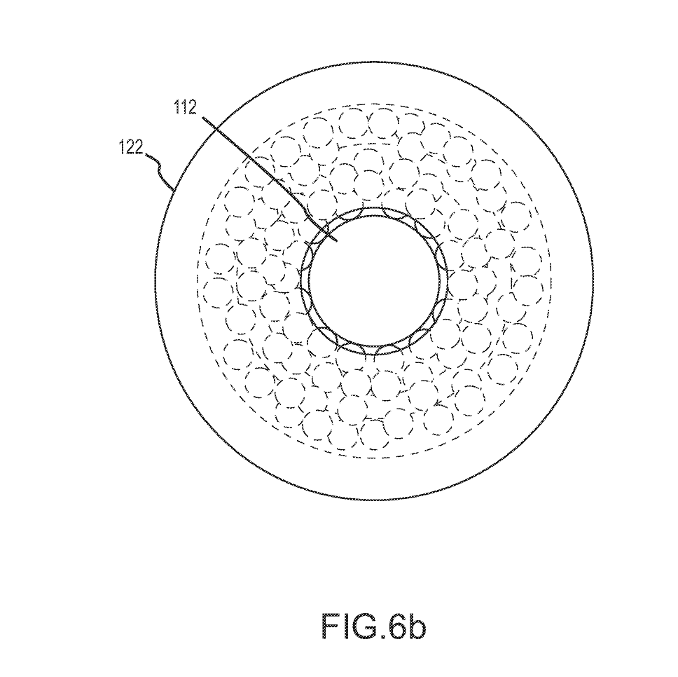

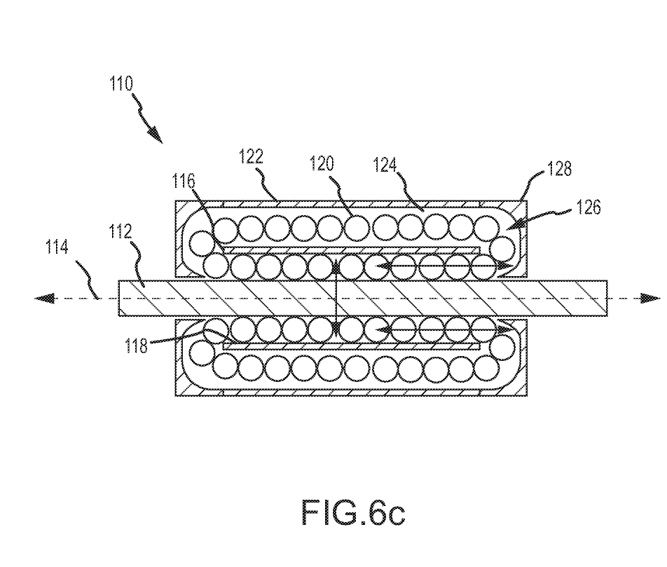

Referring now to FIGS. 6a-6c, an embodiment of a cylindrical two-axis recirculating bearing 110 allows for two-axis translation motion of a cylindrical supported member 112 of diameter D1 along a cylindrical bearing surface; motion both along and around an axis 114 through member 112. Supported member 112 is positioned with an inner cylinder 116 of diameter D2 greater than D1. The inner cylinder's interior cylindrical surface 118 provides the bearing surface. Ball bearings 120 are trapped in an annular region between the cylindrical supported member 112 and inner cylinder 116 along the length of the inner cylinder. The ball bearings are free to roll axially along the bearing surface in response to translational motion of the supported member within the inner cylinder axially along the bearing surface and to roll around the bearing surface in response to translational motion of the supported member radially along the bearing surface. Inner cylinder 116 is mounted axially within an outer cylinder 122 of diameter D3 greater than D2 using, for example, few structural supports 124 to define a recirculating volume 126 as an annular cylindrical volume around the bearing surface. A pair of annular end caps 128 connects the bearing surface to the annular recirculating volume to form the closed track so that ball bearings rolling axially in response to axial translational motion of the supported cylinder recirculate in the closed track.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

1. A recirculating bearing allowing two-axis translational motion of a supported member, comprising:
a plurality of ball bearings;
a bearing surface upon which the ball bearings are free to roll in any direction along the bearing surface, said supported member supported on one or more of the ball bearings allowing two-axis translational motion of the supported member along the bearing surface;
a plurality of retaining elements, each retaining element retaining three ball bearings in a triad configuration that rolls freely in any direction on the bearing surface; and
a recirculating volume connecting opposing ends of the bearing surface to form a closed track for recirculating the ball bearings in response to translational motion of the supported member.

2. The recirculating bearing of claim 1, wherein the ball bearings are free to roll in any direction along the bearing surface and recirculate around the close track to provide the recirculating bearing with an unlimited range of motion in both axes.

3. The recirculating bearing of claim 1, wherein the ball bearings are free to roll in any direction along the bearing surface and recirculate around the close track to provide the recirculating bearing with a range of motion in both axes that exceeds the extent of the bearing surface.

4. The recirculating bearing of claim 1, comprising a surface member that provides the bearing surface and a bearing housing that provides the recirculating volume.

5. The recirculating bearing of claim 1, wherein the recirculating volume encompasses a perimeter of the bearing surface such that motion of the supported member in any direction causes ball bearings to roll off the bearing surface into the recirculating volume and to recirculate in a nominal direction to follow the direction of motion of the supported member.

6. The recirculating bearing of claim 5, wherein the recirculating volume allows at least two ball bearings to move side by side in nominally the same direction.

7. The recirculating bearing of claim 6, comprising a cup having a base, a wall around the periphery of the base and an opening, a pedestal on the base within the walls of the cup, and a disk supported on the pedestal in the opening of the cup,
said disk having a top surface that provides the bearing surface, and
said disk having a lower surface that together with the pedestal, base and walls of the cup forms the recirculating volume.

8. The recirculating bearing of claim 7, wherein the top surface of the disk is curved to provide a curved bearing surface.

9-14. (canceled)

15. The recirculating bearing of claim 1, wherein the supported member comprises a supported cylinder of diameter D1 about an axis, comprising:
an inner cylinder of diameter D2 greater than D1, said inner cylinder having an interior cylindrical surface that provides the bearing surface, said ball bearings being free to roll axially along the bearing surface in response to translation motion of the supported cylinder axially along the bearing surface and to roll around the bearing surface in response to translational motion of the supported cylinder radially along the bearing surface;
an outer cylinder of diameter D3 greater than D2, said inner cylinder mounted axially within the outer cylinder to define the recirculating volume as an annular volume around the bearing surface; and
a pair of annular end caps that connect the bearing surface to the annular recirculating volume to form the closed track, whereby the ball bearings roll axially in response to translational motion of the supported cylinder axially along the bearing surface recirculate in the closed track.

16. A recirculating bearing allowing two-axis translational motion of a supported member, comprising:
a plurality of ball bearings;
a surface member having a bearing surface upon which the ball bearings are free to roll in any direction along the bearing surface, said supported member supported on one or more of the ball bearings allowing two-axis translational motion of the member along the bearing surface;
a plurality of retaining elements, each retaining element retaining three ball bearings in a triad configuration that rolls freely in any direction on the bearing surface; and
a bearing housing having a recirculating volume connecting opposing ends of the bearing surface to form a closed track for recirculating the ball bearings in response to translational motion of the supported member to provide the recirculating bearing with an unlimited range of motion in both axes.

17. The recirculating bearing of claim 16, wherein the recirculating volume encompasses a perimeter of the bearing surface such that motion of the supported member in any direction causes ball bearings to roll of the bearing surface into the recirculating volume and to recirculate in a nominal direction to follow the direction of motion of the supported member.

18. (canceled)

19. The recirculating bearing of claim 16, wherein the supported member comprises a supported cylinder of diameter D1 about an axis, said surface member and bearing housing comprising:
an inner cylinder of diameter D2 greater than D1, said inner cylinder having an interior cylindrical surface that provides the bearing surface, said ball bearings being free to roll axially along the bearing surface in response to translational motion of the supported cylinder axially along the bearing surface and to roll around the bearing surface in response to translational motion of the supported cylinder radially along the bearing surface;
an outer cylinder of diameter D3 greater than D2, said inner cylinder mounted axially within the outer cylinder to define the recirculating volume as an annular volume around the bearing surface; and
a pair of annular end caps that connect the bearing surface to the annular recirculating volume to form the closed track, whereby ball bearings rolling axially in response to translational motion of the supported cylinder axially along the bearing surface recirculate in the closed track.

20. The recirculating bearing of claim 1, wherein each said retaining element is configured to avoid direct contact between adjacent ball bearings.

21. The recirculating bearing of claim 21, wherein each said retaining element is suspended between the three ball bearings above and parallel to the bearing surface.

22. The recirculating bearing of claim 16, wherein each said retaining element is configured to avoid direct contact between adjacent ball bearings.

23. The recirculating bearing of claim 22, wherein each said retaining element is suspended between the three ball bearings above and parallel to the bearing surface.
